(19) United States
(12) Patent Application Publication
(10) Pub. No.: US 2010/0126787 A1
(43) Pub. Date: May 27, 2010

(54) MOVING OBJECT

(76) Inventor: Norihiko Kawada, Toyota-shi (JP)

Correspondence Address: KENYON & KENYON LLP, 1500 K STREET N.W., SUITE 700, WASHINGTON, DC, 20005, US

(21) Appl. No.: 12/605,711

(22) Filed: Oct. 26, 2009

(30) Foreign Application Priority Data
Nov. 27, 2008 (JP) 2008-302315

(51) Int. Cl. B62D 61/00; B62D 11/06

(52) U.S. Cl. 180/21

(57) ABSTRACT

A moving object that moves through inverted pendulum control is equipped with a passenger seat in which a passenger sits, a chassis disposed below the passenger seat, a wheel rotatably mounted on the chassis, a drive portion that rotationally drives the wheel, and a weight unit that is provided at least partially in front of an axle of the wheel.

### INCORPORATION BY REFERENCE

The disclosure of Japanese Patent Application No. 2008-302315 filed on Nov. 27, 2008 including the specification, drawings and abstract is incorporated herein by reference in its entirety.

### BACKGROUND OF THE INVENTION

1. Field of the Invention

The invention relates to a moving object, and more particularly, to a moving object that moves through inverted wheel control.

2. Description of the Related Art

In general, an inverted wheel-type moving object such as an inverted two-wheel vehicle or the like is controlled as to move while the position of a center of gravity of the moving object is modified to maintain the stability thereof by driving the right and left driving wheels. In addition, a construction for driving an inertial body provided above the wheels to stabilize an inverted state is described in, for example, Japanese Patent Application Publication No. 2006-205839 (JP-A-2006-205839). In the inverted wheel-type moving object, the inertial body slides when the inverted wheel-type moving object is in motion. Thus, the center of gravity of the moving object swiftly moves on a vertical line of an axle.

Therefore, the inverted state of the moving object can be stabilized. Further, a carriage body is mounted with a battery for driving a motor. In this inverted wheel-type moving object, the wheels are controlled to hold the moving object inverted in accordance with, for example, an output from a gyro sensor. That is, the wheels need to be controlled such that the center of gravity of the entire moving object is located above the axle in the longitudinal direction of the moving object.

As an example of an inverted wheel-type moving object, there is also developed a moving object provided with a passenger seat (hereinafter “passenger-type moving object”) in which a passenger sits. In the passenger-type moving object, the wheels are driven to stabilize an inverted state of the moving object when a passenger occupies the passenger seat. Further, from a practical point of view, it is preferable to allow the moving object to move even when the passenger does not sit therein.

The position of the center of gravity of the moving object greatly changes depending on whether or not a passenger occupies the moving object. That is, a great gap is created in the longitudinal direction of the moving object between the position of the center of gravity of the moving object when occupied by the passenger and the position of the center of gravity when the moving object is unoccupied. In this case, the angle of inclination at which the moving object may be held inverted when occupied by a passenger is greatly different from the angle of inclination at which the moving object may be held inverted with the passenger not sitting therein. In this case, inversion control needs to be changed.

Alternatively, the height of the moving object from the ground is limited. That is, the dimensional margin of the moving object needs to be increased to prevent a region other than the wheels from coming into contact with the ground. For example, a case where a step panel is provided on the lower side in front of the passenger seat will be taken into account. In this case, when the angle of inclination for holding the moving object inverted greatly changes, the tip of the step panel comes into contact with the ground. In other words, the moving object needs to be designed such that the region other than the wheels does not come into contact with the ground regardless of whether or not the passenger sits in the moving object. Thus, there is a restriction on the design of the moving object, and the size of the step panel or the like is limited. As described hitherto, the inverted wheel-type moving object for passenger use cannot stably move with ease regardless of whether or not a passenger is seated thereon. Further, when the moving object is provided with a slide mechanism as described in Japanese Patent Application Publication No. 2006-205839 (JP-A-2006-205839), the construction of the moving object is complicated.

### SUMMARY OF THE INVENTION

The invention provides a moving object having a simple construction may move stably regardless of whether the moving object is occupied.

A moving object according to one aspect of the invention is a moving object that moves through inverted pendulum control, and is equipped with a passenger seat in which a passenger sits; a chassis disposed below the passenger seat; a wheel rotatably mounted on the chassis; a drive portion that rotationally drives the wheel; and a weight unit that is provided at least partially in front of an axle of the wheel. Thus, the angle of inclination of the moving object in an inverted state can be restrained from changing depending on whether or not the passenger sits therein. Accordingly, the moving object can maintain its balance in the longitudinal direction thereof, and may move stably with a simple construction regardless of whether or not the passenger sits therein.

### BRIEF DESCRIPTION OF THE DRAWINGS

The foregoing and/or further features and advantages of the invention will become more apparent from the following description of an example embodiment with reference to the accompanying drawings, in which like numerals are used to represent like elements and wherein:

FIG. 1 is a perspective view showing a construction of a moving object according to the embodiment of the invention;

FIG. 2 is a view showing the construction of the moving object according to the embodiment of the invention;

FIG. 3 is a perspective view showing the moving object when occupied by a passenger; and

FIG. 4 is a block diagram showing a configuration of a control system of the moving object according to the embodiment of the invention.

### DETAILED DESCRIPTION OF EMBODIMENT

A moving object according to this embodiment of the invention is an inverted wheel-type moving object that moves through inverted pendulum control. The moving object moves to a predetermined position through the driving of wheels on the ground. Furthermore, the moving object may be held inverted by driving the wheels in accordance with an output from a gyro sensor or the like. Further, the moving object moves in accordance with an amount of an operation performed by an operator while being held inverted.

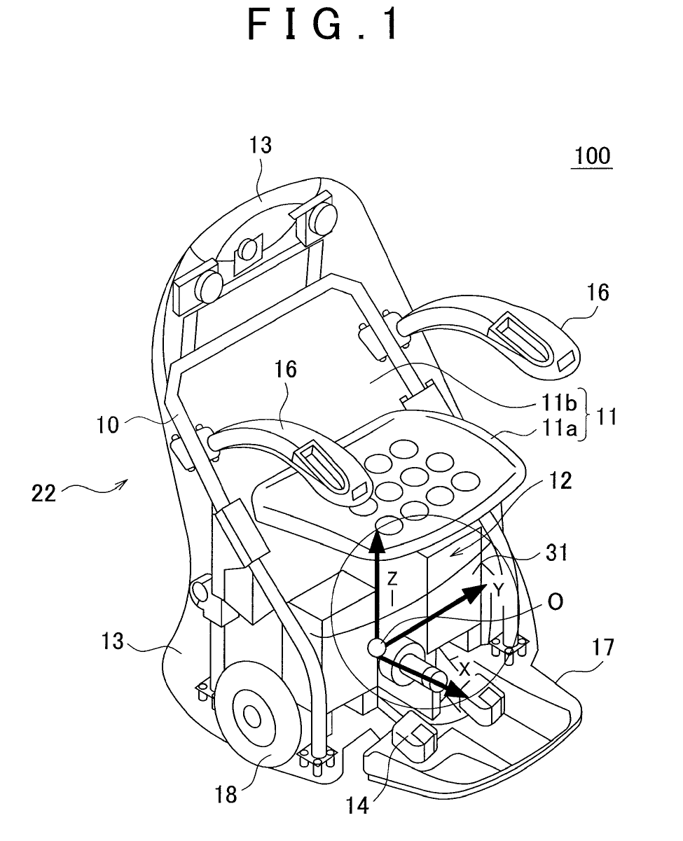

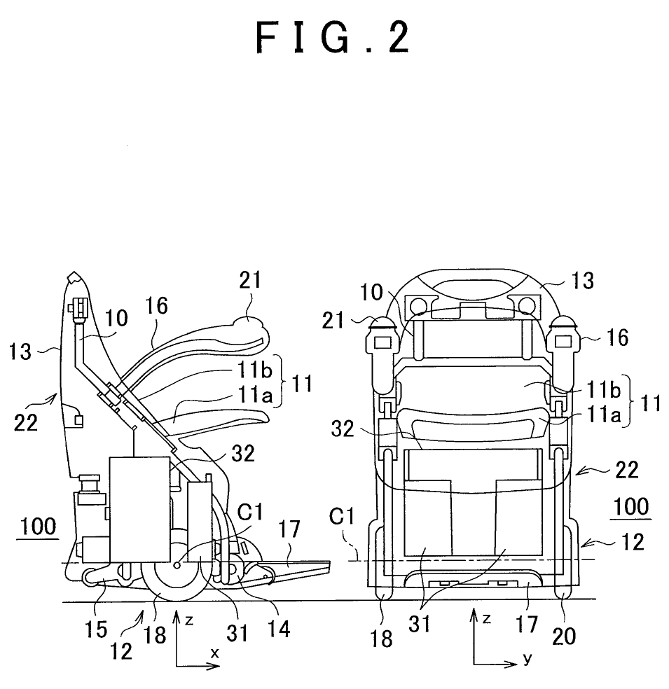

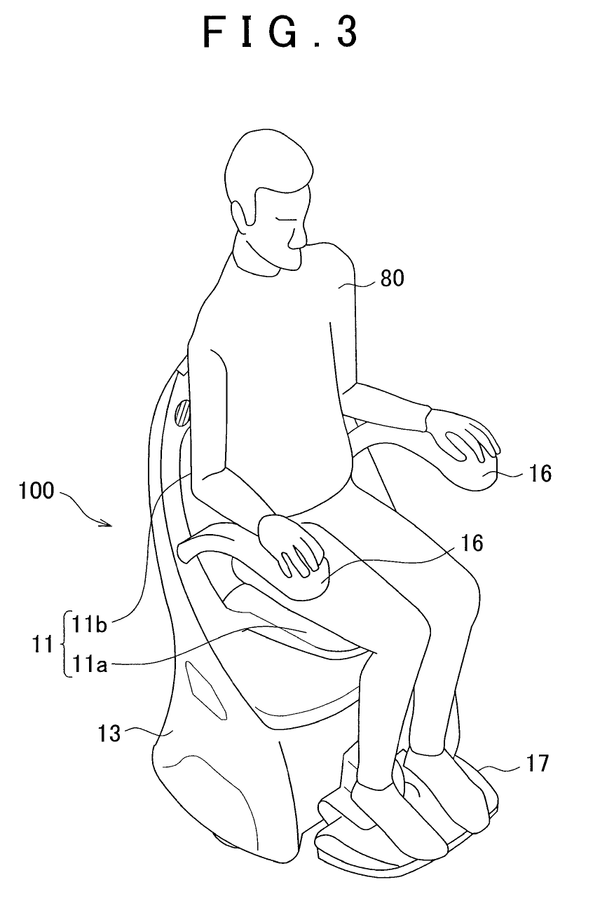

The construction of a moving object 100 according to this embodiment of the invention will be described using FIGS. 1 to 3. FIG. 1 is perspective view schematically showing the construction of the moving object 100. FIG. 2 is a view schematically showing the construction of the moving object 100, consisting of a lateral view on the left side and a front view on the right side. FIG. 3 shows a situation in which an occupant is seated in the moving object 100. It should be noted, as shown in FIGS. 1 and 2, that a forward direction with respect to the moving object 100, a leftward direction with respect to the moving object 100, and an upward direction with respect to the moving object 100 are referred to as a +X direction, a +Y direction, and a +Z direction respectively. Further, in FIGS. 1 and 2, the construction of the moving object 100 is partially shown as a through-view for the sake of intelligible explanation.

The moving object 100 is an inverted wheel-type moving object (a mobile object). As shown in FIG. 2, the moving object 100 is equipped with a right driving wheel 18 and a left driving wheel 20 that are disposed coaxially with each other. It is assumed herein that a rotational shaft for the right driving wheel 18 and the left driving wheel 20 is referred to as an axle C1. The moving object 100 includes a passenger seat 11 to seat a passenger. Accordingly, the moving object 100 is a sitting posture-type mobility robot that can move with a person seated thereupon. Further, the moving object 100 may also move w when unoccupied. For example, when a user wishing to get on the moving object 100 performs a remote operation, the moving object 100 moves to the position of the user. For example, when the user presses a calling button or the like, the moving object 100 moves toward the user. Then, after the moving object stops in front of the user wishing to move, the user gets on the moving object.

The moving object 100 is provided with a frame 10 that serves as a skeleton thereof. The frame 10 is constructed of a light aluminum pipe or the like. In addition, the moving object 100 is provided with a cover 13 for covering the frame 10. The cover 13 covers a later-described chassis 12 and the like. The moving object 100 is provided with a chair-shaped passenger seat 11. The passenger seat 11 is fixed to the cover 13 and the frame 10. The frame 10 and the cover 13 are bent along the shape of the passenger seat 11.

The passenger seat 11 has a seat 11a and a seatback 11b. The seat 11a serves as a sitting surface on which a passenger 80 sits, and hence is disposed substantially horizontally. When the passenger 80 sits on the seat 11a, the moving object 100 can thereby move with the passenger 80 seated thereon as shown in FIG. 3. The seatback 11b extends from the rear of the seat 11a diagonally backward and upward, and serves as a seatback portion for supporting the back of the passenger 80. Accordingly, the moving object 100 moves with the passenger 80 leaning against the seatback 11.

The chassis 12 is disposed directly below the passenger seat 11. The chassis 12 includes the right driving wheel 18 and the left driving wheel 20. The chassis 12 rotatably supports the right driving wheel 18 and the left driving wheel 20. The right driving wheel 18 and the left driving wheel 20 are used to move the moving object 100. The right driving wheel 18 and the left driving wheel 20 rotate around the axle Cl. That is, the right driving wheel 18 and the left driving wheel 20 are disposed coaxially with each other. The chassis 12 is mounted on the frame 10.

A motor (not shown) for driving the right driving wheel 18 and the left driving wheel 20 is mounted on the chassis 12. Further, because the moving object 100 is an inverted wheel-type moving object, a vehicle body 22 (an upper body portion) including the passenger seat and the like tilts around the axle Cl. That is, the vehicle body 22 including the passenger seat 11 and the like is rotatably supported. The vehicle body 22 serves as an upper body portion that rotates around the axle Cl. In other words, the vehicle body 22 is that region which tilts around the axle C1. This vehicle body 22 includes the frame 10, the cover 13, the passenger seat 11, and the like. Furthermore, the chassis 12 may be partially or entirely included by the vehicle body 22. In an inverted state, the angle of inclination of the vehicle body 22 changes through the driving of the right driving wheel 18 and the left driving wheel 20. The vehicle body 22 is provided with a gyro sensor for measuring the angle of inclination, and the like. As shown in FIG. 1, a midpoint between the right driving wheel 18 and the left driving wheel 20 is defined as a coordinate center O. That is, the coordinate center O, which is an origin of a coordinate system, exists on the axle C1. The traveling direction of the moving object 100 is perpendicular to the axle C1 on a horizontal plane.

A step panel 17 is provided at the front of the chassis 12. The passenger 80 gets on the step panel 17 and then sits in the passenger seat 11. The step panel 17 is mounted to a lower side of the passenger seat 11. Further, the step panel 17 extends forward of the passenger seat 11. As shown in FIG. 3, both feet of the passenger 80 are laid on the step panel 17. The step panel 17 is mounted to the chassis 12.

Further, the step panel 17 is provided at a midway portion thereof with a front bar 14 for preventing the moving object 100 from tipping forward. Further, a rear bar 15 for preventing the moving object 100 from tipping rearward. That is, the front bar 14 disposed in front of the axle C1 and the rear bar 15 disposed behind the axle C1 can prevent the moving object 100 from being tipped in the longitudinal direction. The front bar 14 protrudes forward of the chassis 12, and the rear bar 15 protrudes backward of the chassis 12. Accordingly, a tip of the front bar 14 comes into contact with the ground when the moving object 100 tilts excessively forward, and a tip of the rear bar 15 comes into contact with the ground when the moving object 100 tilts excessively backward.

The front bar 14 and the rear bar 15 can be rotationally driven. Rotational shafts of the front bar 14 and the rear bar 15 are disposed below (on a −Z side with respect to) the axle C1 for the right driving wheel 18 and the left driving wheel 20. Further, auxiliary wheels are provided at the tips of the front bar 14 and the rear bar 15, respectively. In the inverted state, the auxiliary wheel provided on the front bar 14 and rear bar 15 are not in contact with the ground. In contrast, when a passenger 80 is getting on or off the moving object 100 the auxiliary wheels come into contact with the ground.

The passenger seat 11 is provided on both sides thereof with arm rests 16. The arm rests 16 are fixed to the frame 10 and the cover 13. The arm rests 16 extend forward from positions slightly below the elbows of the passenger 80 respectively. The arm rests 16 are disposed higher than the seat 11a. Further, the arm rests 16 are substantially parallel to the seat 11a. The arm rests 16 are disposed on the right and left sides of the passenger seat 11 respectively. Thus, the passenger 80 can lay both his/her arms on the respective arm rests 16. The arm rests 16 are mounted to an intermediate stage of the seatback 11b. As shown in FIG. 3, the passenger 80 sits with both his/her hands laid on the respective arm rests 16.

Furthermore, the arm rests 16 are provided with an operation module 21.

It should be noted herein that the operation module 21 is mounted on the right arm rest 16. Further, the operation module 21 is mounted near the tip of the arm rest 16. Thus, the operation module 21 is disposed at a position of the right hand of the passenger 80 and hence allows an improvement in operability. The operation module 21 is provided with an operation lever (not shown) and a brake lever (not shown). The operation lever is an operation member for helping the passenger adjust the speed of the moving object 100 and the direction of the moving object 100. The passenger can adjust the speed of the moving object 100 by adjusting the operation amount of the operation lever. Further, the passenger may designate the moving direction of the moving object 100 by adjusting the operation direction of the operation lever. In accordance with the type of operation exerted on the operation lever, the moving object 100 may advance, stop, retreat, make a left turn, make a right turn, pivot leftward, or pivot rightward. The passenger may brake the moving object 100 by tumbling the brake lever. As a matter of course, the operation module 21 may be mounted on the left arm rest 16. It is also appropriate to mount operation modules 21 on both the arm rests 16 respectively. Furthermore, the operation module 21 may be mounted on a member other than the arm rests 16.

Two batteries 31 and a control box 32 are mounted on the chassis 12. The longitudinal positions of the batteries 31 and the control box 32 with respect to the axle C1 change in accordance with the angle of inclination of the vehicle body 22. The chassis 12 is provided with a base plate on which the batteries 31 and the control box 32 are laid. Accordingly, the batteries 31 and the control box 32 are disposed directly below the seat 11a. In this case, the two batteries 31 are disposed in front of the control box 32. The two batteries 31 are arranged along the Y direction. The batteries 31 are rechargeable secondary batteries. The charge/discharge of the batteries 31 is controlled by the control box 32.

The control box 32 includes a central processing unit (CPU), a read only memory (ROM), a random access memory (RAM), a communication interface, and the like, and controls various movements of the moving object 100. The control box 32 executes various controls according to a control program stored in, for example, the ROM. The control box 32 controls the motor and the like through a conventional feedback control such as robust control, state feedback control, PID control, or the like to hold the moving object 100 inverted. Thus, the moving object 100 travels while accelerating/decelerating in accordance with the operation of the operation module 21.

Further, the batteries 31 and the control box 32 are installed above the axle C1. The batteries 31 are located in front of (on the +X side with respect to) the axle C1, and the control box 32 is disposed behind (on the −X side with respect to) the axle C1. In this case, the control box 32 is disposed apart from the batteries 31. That is, the control box 32 is disposed opposite and apart from the batteries 31 by a certain distance directly above the axle C1. By disposing the batteries 31 in front of the axle C1, the center of gravity of the vehicle body 22 may be located directly above the axle C1. The center of gravity of the vehicle body 22 is located substantially directly above the axle C1 when the angle of inclination of the vehicle body 22 remains unchanged, regardless of whether or not a passenger 80 is in the moving object 100. This will be described below.

First, the position of the center of gravity of the moving object 100 will be described. In the inverted wheel-type moving object 100, with a view to holding the moving object 100 inverted, the vehicle body 12 is disposed such that the center of gravity thereof is located directly above the axle C1. Further, the center of gravity of the vehicle body 12 needs to be located on a vertical line extending past the axle C1 regardless of whether a passenger 80 is seated on the moving object 100. It should be noted that the empty weight of the moving object 100 (the weight of the moving object 100 with no passenger sitting therein) is lighter than the weight of the entire moving object 100 including the passenger 80. Further, the body of the moving object 100 is about the same as or lighter than that of the passenger 80. In particular, it is preferable to reduce the weight of the moving object 100 from the standpoint of size reduction of the motor and the like. For example, the moving object 100 weighs about 67 kg and is approximately as heavy as or lighter than the passenger 80.

The sitting posture-type moving object 100 is designed in consideration of riding comfort of the passenger 80. Therefore, the position of the center of gravity of the moving object 100 with the passenger 80 sitting therein is important. Accordingly, the moving object 100 is designed such that the center of gravity of the moving object 100 and the passenger 80 with a standard body type is located near a position directly above the axle C1. In this manner, the angle of inclination of the vehicle body during the movement of the moving object 100 in the inversed state may be reduced. That is, since the center of gravity of the moving object 100 is located directly above the axle C1 during the movement of the moving object 100 in the inversed state, the angle of inclination of the vehicle body 22 is small. The seat 11a of the passenger seat 11 is horizontal, and the riding comfort is improved. Thus, the position of the passenger seat 11 in the longitudinal direction of the moving object 100 (in the X direction) is designed such that the center of gravity of the passenger 80 is located close to the axle C1. That is, the longitudinal position of the passenger seat 11 with respect to the chassis 12 is determined in consideration of the center of gravity of the passenger 80.

When the moving object 100 is not occupied, the center of gravity of the vehicle body 22 including the passenger 80 is deviant. The passenger 80 is approximately as heavy as or heavier than the moving object 100. Therefore, the center of gravity of the vehicle body 22 greatly changes depending on whether or not the passenger 80 is in the moving object 100. To hold the moving object 100 inverted when it is not occupied, the vehicle body 22 is more inclined than in the case where the passenger 80 is in the moving object 100. In other words, because the passenger 80 is heavier than the moving object 100, and therefore, the center of gravity of the vehicle body 22 is close to the position directly above the axle C1 when the passenger is seated on the moving object 100, even if the center of gravity of the vehicle body 22 is located behind the axle C1 when the passenger is not in the moving object 100. Accordingly, the angle of inclination of the vehicle body 22 changes depending on whether or not a passenger 80 is in the moving object 100. Especially in the case where the moving object 100 is provided with the step panel 17, the front bar 14, and the rear bar 15, these components come into contact with the ground when the angle of inclination of the vehicle body 22 increases. Thus, the moving object 100 cannot stably run with ease.

Owing to the design of the moving object 100, the center of gravity of the vehicle body 22 is located behind (on the −X side with respect to) the axle C1 when the moving object 100 is unoccupied. Accordingly, if the center of gravity of the vehicle body 22 is located directly above the axle when the passenger is in the moving object 100, the center of gravity of the vehicle body 22 is located behind the axle C1 when the passenger is not in the moving object 100. Thus, in this embodiment of the invention, the batteries 31 are installed in front of the axle C1. That is, the batteries 31 are disposed on the +X side with respect to the axle C1.

In general, the batteries 31 are the heaviest electric unit components mounted on the moving object 100. For example, it is assumed that the total weight of the entire electric unit is about 10 kg, and that the weight of each of the batteries 31 is about 3.5 kg. In this case, because the moving object 100 is provided with the two batteries 31, the total weight of the batteries 31 is about 7 kg. Thus, the ratio of the weight of the batteries 31 to the total weight of the electric unit is about 70%. In particular, when the passenger 80 is not in the moving object 100, the moving object 100 is not so heavy, and hence the disposition of the batteries 31 is important. That is, the center of gravity of the vehicle body 22 may be located above the axle C1 in accordance with the disposition of the batteries 31. On the other hand, the total weight is heavier when the passenger 80 is in the moving object 100. Thus, the change in the position of the center of gravity of the vehicle body 22 is small even when the center of gravity shifts to a position in front the batteries 31. Thus, the center of gravity of the vehicle body 22 can be located directly above the axle C1 even when the passenger is in the moving object 100.

As described above, the very heavy components in the electric unit, namely, the batteries 31 are disposed in front of the axle C1. Thus, the position of the center of gravity of the vehicle body 22 can be restrained from changing depending on whether or not the passenger 80 is in the moving object 100. Accordingly, the change in the angle of inclination of the vehicle body 22 is small, and the moving object 100 can stably travel in any state. Further, the change in the angle of inclination of the vehicle body 22 is small. Therefore, the step panel 17, the front bar 14, the rear bar 15, and the like can be distanced from the ground. That is, the dimensional margin of the moving object 100 with respect to the ground can be reduced, and the degree of freedom in designing the moving object 100 is thereby enhanced. Therefore, the moving object 100 can obtain a space saving structure, and a contribution to the size reduction of the moving object 100 can be made.

Further, the passenger seat 11 is provided with the seatback 11b, and hence the center of gravity of the entire moving object including the passenger 80 tends to be located on the rear side. In the construction in which the passenger seat 11 is provided with the seatback 11b, the rear side of the moving object 100 is heavy. When the passenger 80 leans against the seatback 11b, the center of gravity of the moving object 100 tends to be located on the rear side. That is, when the passenger 80 leans against the seatback, the center of gravity of the entire moving object including the passenger 80 shifts to a position behind the axle C1. In this case as well, because the batteries 31 are disposed toward the front, the moving object 100 can move stably.

Furthermore, the batteries 31 are disposed toward the front, and the control box 32, which is lighter than the batteries 31, is disposed toward the rear. That is, the control box 32 is disposed behind the axle C1. Thus, the unnecessary space directly below the seat 11a may be reduced. Accordingly, the space for the moving object 100 can be saved, and a contribution to the size reduction of the moving object 100 can be made.

For example, if the batteries 31 are disposed behind the axle C1 and a coordinate (x, y, z) of the center of gravity of the vehicle body 22 is (−23, 2, 159) when a passenger is seated on the moving object 100, and the center of gravity of the vehicle body 22 is located behind the axle C1 by 23 mm. In this case, the vehicle body 22 needs to be inclined forward by 8.2° to hold the unoccupied moving object 100 inverted. On the other hand, when the batteries 31 are disposed in front of the axle C1, the coordinate (x, y, z) of the center of gravity of the vehicle body 22 is (1, 2, 159). That is, the center of gravity of the vehicle body 22 deviates from the axle C1 only by 1 mm In this case, even when the moving object 100 is unoccupied, the moving object 100 may be held inverted by inclining the vehicle body 22 backward only by 0.36°. In these examples, the center of gravity of the vehicle body 22 is located substantially directly above the axle C1 when the passenger is seated in the moving object 100. In this manner, by disposing the batteries 31 on the front side, the angle of inclination of the vehicle body 22 is restrained from changing depending on whether the passenger 80 is seated in the moving object 100. Accordingly, the moving object 100 can move stably.

Further, the weight balance of the moving object 100 is adjusted by adjusting the disposition of the existing batteries 31. Therefore, there is no need to lay any additional weight on the moving object 100. As a result, the weight of the moving object 100 is not increased. Further, there is no need to separately provide a slide mechanism for shifting the center of gravity of the vehicle body 22 or the like. Mechanical simplification and cost reduction can be achieved.

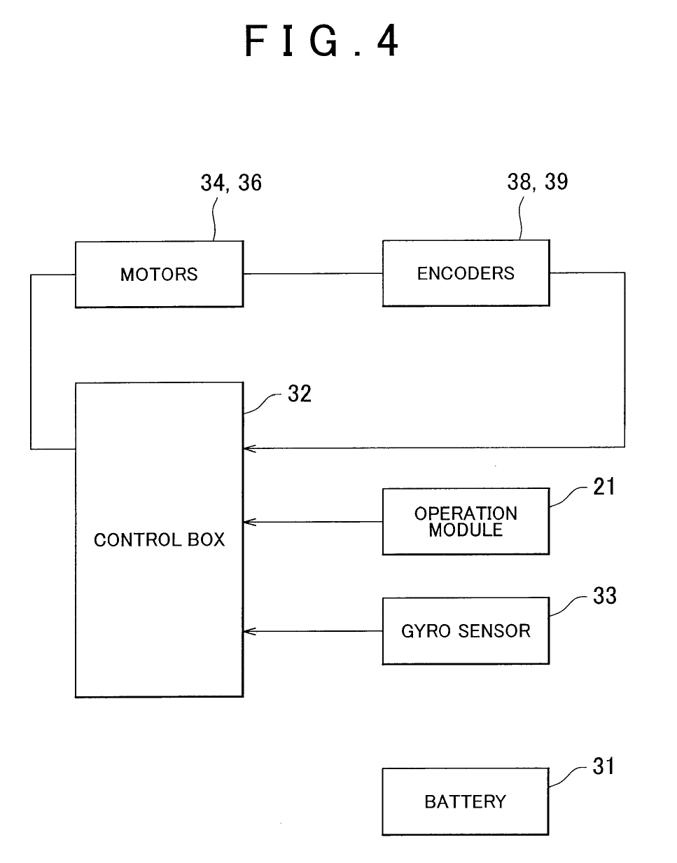

Next, the configuration of a control system of the moving object 100 will be described using FIG. 4. FIG. 4 is a block diagram showing the configuration of the control system including the control box 32.

The signal from a gyro sensor 33 provided on the vehicle body 22 is input to the control box 32. That is, an angle of inclination detected by the gyro sensor 33 is input to the control box 32. The gyro sensor 33 is installed on, for example, the vehicle body 22.

More specifically, the gyro sensor 33 is fixed to the chassis 12 near a coordinate center 0. Further, an operation amount of the operation module 21 is input to the control box 32. For example, a translational speed of the moving object 100 in the longitudinal direction thereof, a right or left pivoting speed of the moving object 100, or the like is input from the operation module 21 as an operation amount. Rotational speeds of motors 34 and 36 are input to the control box 32 from encoders 38 and 39 respectively.

Based on these input values, the control box 32 outputs command torques to the motors 34 and 36, which drive the right driving wheel 18 and the left driving wheel 20 respectively. That is, the motor 34 rotationally drives the right driving wheel 18 in accordance with the command torque, and the motor 36 rotationally drives the left driving wheel 20 in accordance with the command torque. It should be noted that motive powers from the motors 34 and 36 are transmitted to the right driving wheel 18 and the left driving wheel 20 via pulleys or the like respectively.

The control box 32 performs inverted control calculation based on an operation amount from the operation module 21 and a detection signal from the gyro sensor 33, and calculates a control target value. In addition, the control box 32 calculates the current rotational speeds of the motors and a difference in target rotational speed corresponding to the control target value. The control box 32 then multiplies this difference by a predetermined feedback gain to perform feedback control. The control box 32 outputs command values to the motors 34 and 36 that correspond to the driving torques respectively via an amplifier or the like. Thus, the moving object 100 moves at a speed corresponding to the operation amount and in a direction corresponding to the operation amount.

It should be noted that the batteries 31 supply electric power to the respective electric components of the control box 32, the operation module 21, the gyro sensor 33, the motors 34 and 36, the encoders 38 and 39, and the like. That is, the electric power supply voltage supplied from the batteries 31 serves to operate all, some, or one of the electric components mounted on the moving object 100.

Although the two-wheeled moving object has been described in the foregoing example, the invention is not limited thereto. That is, the invention is also applicable to an inverted wheel-type moving object having one wheel or an inverted wheel-type moving object having three or more wheels.

While the invention has been described with reference to the example embodiment thereof, it should be understood that the invention is not limited to the described embodiment or construction. To the contrary, the invention is intended to cover various modifications and equivalent arrangements. In addition, while the various elements of the example embodiment are shown in various combinations and configurations, other combinations and configurations, including more, less or only a single element, are also within the spirit and scope of the invention.

What is claimed is:

1. A moving object that moves through inverted pendulum control, comprising:
a passenger seat in which a passenger sits;
a chassis disposed below the passenger seat;
a wheel rotatably mounted on the chassis;
a drive portion that rotationally drives the wheel; and
a weight unit that is provided at least partially in front of an axle of the wheel.

2. The moving object according to claim 1, wherein the weight unit is provided such that a center of gravity thereof is located in front of the axle of the wheel.

3. The moving object according to claim 1, wherein the weight unit is a battery that supplies the drive portion with electric power.

4. The moving object according to claim 3, further comprising a control portion that is lighter than the battery and provided behind the axle to control the drive portion.

5. The moving object according to claim 1, wherein the passenger seat includes a seatback.

6. The moving object according to claim 1, wherein the passenger seat is located such that a center of gravity of the passenger in a longitudinal direction of the moving object is located close to a position directly above the axle.

7. The moving object according to claim 1, further comprising a tip-prevention bar that protrudes from the chassis in a longitudinal direction of the moving object to prevent the moving object from being tipped.

8. The moving object according to claim 7, wherein the tip-prevention bar comes into contact with a ground when the passenger gets on or off the moving object.
